(19) United States
(12) Patent Application Publication
(10) Pub. No.: US 2025/0291946 A1
(43) Pub. Date: Sep. 18, 2025

(54) MAINTAINING NON-ACCESS-RESTRICTED AND ACCESS-RESTRICTED DATABASES TO MITIGATE AND/OR ELIMINATE INSTANCES OF OUTGOING ELECTRONIC COMMUNICATIONS THAT ARE INITIATED IN RESPONSE TO RECEIVING REQUESTS FROM USERS

(71) Applicant: GOOGLE LLC, Mountain View, CA (US)

(72) Inventors: Yoav Tzur, Tel Aviv (IL); Oded Meri, Tel Aviv (IL)

(21) Appl. No.: 18/903,912

(22) Filed: Oct. 1, 2024

Related U.S. Application Data
(60) Provisional application No. 63/564,853, filed on Mar. 13, 2024.

(51) Int. Cl. G06F 21/62

(52) U.S. Cl. CPC G06F 21/6227

(57) ABSTRACT

Implementations are directed to maintaining non-access-restricted database(s) that are general to a plurality of users and access-restricted database(s) that are specific to a user, and subsequently using the non-access-restricted database(s) and/or the access-restricted database(s) in responding to requests provided by users. For example, processor(s) of a system can determine content of a conversation between a user and an additional user and store portion(s) of the content of the conversation in the non-access-restricted database(s) based on the content being non-personal content and/or the access-restricted database(s) based on the content being personal content. Accordingly, when a user provides a request, the processor(s) can initially cause a search to be performed over the non-access-restricted database(s) and/or the access-restricted database(s) in an attempt to satisfy the request. Assuming the request can be satisfied based on the search, the processor(s) can render portion(s) of the content of the conversation for presentation to the user.

### BACKGROUND

Humans may engage in human-to-computer dialogs with interactive software applications referred to as “chatbots,” “automated assistants”, “intelligent personal assistants,” etc. (referred to herein as “automated assistants”). As one example, these automated assistants may correspond to a machine learning model or a combination of different machine learning models, and may be utilized to respond to requests provided by users. Further, and to satisfy some of these requests, these automated assistants can initiate outgoing electronic communications. For instance, these automated assistants can, on behalf of users, initiate automated telephone calls and conduct conversations with various human users or other automated assistants to inquire about inventory of a certain product, check availability for appointments, etc. In conducting these conversations, these automated assistants can cause corresponding instances of synthesized speech to be rendered at a corresponding client device of the various human users or other automated assistants, and receive instances of corresponding audio data from the various human users or other automated assistants. Based on the instances of the synthesized speech and/or the instances of the audio data, these automated assistants can then alert the user as to a result of these telephone calls, thereby satisfying the requests.

However, many of these outgoing electronic communications may be duplicative, thereby wasting computational and/or network resources. For instance, if a user requests that a respective instance of an automated assistant call a particular business to inquire about availability of a certain product, then the respective instance of the automated assistant may initiate an automated telephone call directed to the particular business, inquire about the availability of the certain product, and then notify the user about the availability of the certain product. Further, if an additional user requests that a respective additional instance of the automated assistant call the particular business to inquire about availability of the certain product, then the respective additional instance of the automated assistant may initiate an additional automated telephone call directed to the particular business, inquire about the availability of the certain product, and then notify the additional user about the availability of the certain product. In this instance, the automated assistant wastes computational and/or network resources by initiating and conducting the additional automated telephone call since the automated assistant already knows the availability of the certain product from the automated telephone call.

Also, for instance, if a user and an additional user have a conversation about a particular topic at an initial time, then the user desires to re-visit the particular topic that was previously discussed at a subsequent time (e.g., several days, weeks, months, or years after the initial time), then the user may request that the automated assistant initiate and conduct an automated telephone call with the additional user or generating and sending an automated message (e.g., dictated by the user) to discuss content of the particular topic. In this instance, the automated assistant also wastes computational and/or network resources by initiating and conducting the automated telephone call with the additional user and/or by generating and sending the automated message at the subsequent time. Accordingly, there is a need in the art to maintain various non-access-restricted databases and access-restricted databases to mitigate and/or eliminate consumption of computational resources and/or network resources based on instances of these outgoing electronic communications.

### SUMMARY

Implementations described herein are directed to maintaining non-access-restricted database(s) that are general to a plurality of users and access-restricted database(s) that are specific to a user, and subsequently using the non-access-restricted database(s) and/or the access-restricted database(s) in responding to requests provided by users. For example, processor(s) of a system can determine content of a conversation between a user and an additional user (or an automated assistant) and store portion(s) of the content of the conversation in the non-access-restricted database(s) based on the content being non-personal content and/or the access-restricted database(s) based on the content being personal content. Accordingly, when a user provides a request, the processor(s) can initially cause a search to be performed over the non-access-restricted database(s) and/or the access-restricted database(s) in an attempt to satisfy the request. Assuming the request can be satisfied based on the search, the processor(s) can render portion(s) of the content of the conversation for presentation to the user.

In some implementations, and in determining the content of the conversation between the user and the additional user (or the automated assistant), the processor(s) can process, using an automatic speech recognition (ASR) model, a stream of audio data that captures the conversation to generate ASR output (e.g., recognized text of the conversation or other ASR output described herein), and determine the content of the conversation based on processing the ASR output. For example, the user and the additional user (or the automated assistant) can be engaged in the conversation during a telephone call, in-person, or otherwise. In this example, microphones of client device(s) in an environment of the user and/or the additional user can generate the stream of audio data which is then processed to determine the content of the conversation.

In some versions of those implementations, and in determining whether the content of the conversation between the user and the additional user (or the automated assistant) is personal content or non-personal content, the processor(s) can process the ASR output using one or more additional machine learning (ML) model(s) (e.g., using a natural language understanding (NLU) model to generate NLU output, a large language model (LLM) to generate LLM output, other generative model(s) (GM(s)) to generate GM output(s), etc.) to generate output. Based on the output generated using one or more of the additional ML models, the processor(s) can determine whether the content of the conversation is personal content or non-personal content, and optionally utilizing classification ML model(s) to process the output generated using one or more of the additional ML models. Notably, these classification ML model(s) can be previously trained to determine, based on the output generated using one or more of the additional ML models, whether the portion(s) of the content are personal content or non-personal content.

For example, the user and the additional user (or the automated assistant) may converse about philosophical beliefs, favorites sports teams, medical conditions, upcoming events, and/or other topics that the classification ML model(s) would determine is personal content. Accordingly, in this example, the processor(s) can cause these portion(s) of the content of the conversation to be stored in access-restricted database(s) that is specific to the user and/or the additional user. As another example, the user and the additional user (or the automated assistant) may converse about availability of certain products at a business, services offered by a business, operating hours of a business, and/or other topics that the classification ML model(s) would determine is non-personal content. Accordingly, in this example, the processor(s) can cause these portion(s) of the content of the conversation to be stored in non-access-restricted database(s) that is general to a plurality of users. Notably, the content of the conversation between the user and the additional user (or the automated assistant) may include only personal content, only non-personal content, or both personal content and non-personal content.

In additional or alternative versions of those implementations, and in determining whether the content of the conversation between the user and the additional user (or the automated assistant) is personal content or non-personal content, the processor(s) can determine a relationship between the user and the additional user. Based on the relationship between the user and the additional user, the processor(s) can determine whether the content of the conversation is personal content or non-personal content. For example, assume that the user and the additional user are family members, friends, or co-workers (e.g., personal entities, that can optionally be defined by the user). In this example, the processor(s) can determine that the content of the conversation is personal content regardless of topics that are discussed during the conversation. Accordingly, portion(s) of the content of the conversation may only be stored in the access-restricted database(s) that are specific to the user and the additional user. However, assuming that there is no known relationship between the user and the additional user, the processor(s) can determine that the content of the conversation is non-personal content, unless the classification ML model(s) indicate otherwise (e.g., the additional user is the user's doctor or lawyer, and they are discussing sensitive information).

In some implementations, and assuming that the processor(s) have maintained the non-access-restricted database(s) and/or the access-restricted database(s), the processor(s) may receive user input from the user that includes a request directed to an automated assistant (e.g., that is accessible at a client device of the user). Further, the processor(s) can determine whether the request is a personal request or non-personal request. In some versions of those implementations, the processor(s) can utilize classification ML model(s) and/or a relationship associated with the request (e.g., whether the request is associated with a personal entity) to determine whether the request is a personal request or non-personal request.

Further, and assuming that the request included in the user input is a personal request, the processor(s) can cause an access-restricted search to be executed over an access-restricted database that is specific to the user that provided the user input, and determine, based on access-restricted content obtained responsive to the access-restricted search over the access-restricted database that is personal to the user, whether the request can be satisfied using the access-restricted content. For example, the processor(s) can generate a personal search query, and execute the personal search query over the access-restricted database(s) to obtain the access-restricted content. The personal search query can include, for example, an entity reference to an entity that is included in the request and/or other search terms that are dependent on the request that was included in the user input. In these implementations, and in determining whether the request can be satisfied using the access-restricted content, the processor(s) can determine whether portion(s) of the access-restricted content are responsive to the request to determine whether the request can be satisfied using the access-restricted database(s).

In some versions of those implementations, if none of the portion(s) of the access-restricted content are responsive to the request, the processor(s) can cause a search to be executed over a non-access-restricted database that is general to a plurality of users, the plurality of users including the user and additional users, and determine, based on non-access-restricted content obtained responsive to the search over the non-access-restricted database that is general to the plurality of users, whether the request can be satisfied using the non-access-restricted content. For example, the processor(s) can generate a non-personal search query, and execute the non-personal search query over the non-access-restricted database(s) to obtain the non-access-restricted content. Similarly, the non-personal search query can include, for example, the entity reference to the entity that is included in the request and/or other search terms that are dependent on the request that was included in the user input. In these implementations, and in determining whether the request can be satisfied using the non-access-restricted content, the processor(s) can determine whether portion(s) of the non-access-restricted content are responsive to the request to determine whether the request can be satisfied using the non-access-restricted database(s).

In additional or alternative versions of those implementations, if none of the portion(s) of the access-restricted content and/or portion(s) of the non-access-restricted content are responsive to the request, the processor(s) can cause a recommendation to initiate an outgoing electronic communication to be rendered at the client device. The outgoing electronic communication can be, for example, an automated telephone call that is initiated and conducted by the automated assistant and on behalf of the user, an automated message that is generated and sent by the automated assistant and on behalf of the user, and/or other outgoing electronic communications. Put another way, the processor(s) can attempt to satisfy the request using content stored in the access-restricted database and/or the non-access-restricted database in an attempt to obviate the need to initiate any outgoing electronic communication, thereby conserving computational and/or network resources at a client device of the user and/or other client device(s) of other user(s).

Moreover, and assuming that the request included in the user input is a non-personal request, the processor(s) can refrain from causing any access-restricted search to be executed over the access-restricted database that is specific to the user. Rather, in these implementations, the processor(s) can cause the search to be executed over the non-access-restricted database that is general to the plurality of users, and determine, based on the non-access-restricted content obtained responsive to the search over the non-access-restricted database that is general to the plurality of users, whether the request can be satisfied using the non-access-restricted content.

In some versions of those implementations, if none of the portion(s) of the non-access-restricted content are responsive to the request, the processor(s) can cause the recommendation to initiate the outgoing electronic communication to be rendered at the client device. Put another way, the processor(s) can attempt to satisfy the request using content stored in the non-access-restricted database (but not the access-restricted database) in an attempt to obviate the need to initiate any outgoing electronic communication, thereby conserving computational and/or network resources at a client device of the user and/or other client device(s) of other user(s).

By maintaining the access-restricted database and/or the non-access-restricted database and subsequently using the access-restricted database and/or the non-access-restricted database in responding to requests received from users, one or more technical advantages can be achieved. For example, computational resources and/or battery resources can be conserved not only at a client device of the user that provided the request, but also at an additional client device of an additional user, by mitigating and/or eliminating instances of outgoing electronic communications being initiated and/or conducted between the user and the additional user via the client device and the additional client device, respectively. As another example, data security of personal data of users is increased by maintaining the separate access-restricted database that is specific to a given user and the non-access-restricted database that is general to a plurality of users.

The above description is provided as an overview of only some implementations disclosed herein. Those implementations, and other implementations, are described in additional detail herein.

### BRIEF DESCRIPTION OF THE DRAWINGS

FIG. 1 depicts a block diagram of an example environment that demonstrates various aspects of the present disclosure, and in which implementations disclosed herein can be implemented.

FIG. 2 depicts an example process flow using various components from the example environment from FIG. 1, in accordance with various implementations.

FIG. 3 depicts a flowchart illustrating an example method of maintaining non-access-restricted database(s) and access-restricted database(s), in accordance with various implementations.

FIG. 4 depicts a flowchart illustrating an example method of searching non-access-restricted database(s) and access-restricted database(s) in furtherance of satisfying a request, in accordance with various implementations.

FIGS. 5A, 5B, 5C, and 5D depict various non-limiting examples of maintaining non-access-restricted database(s) and/or access-restricted database(s) and subsequently searching the non-access-restricted database(s) and/or the access-restricted database(s) in furtherance of satisfying a request, in accordance with various implementations.

FIGS. 6A and 6B depict various additional non-limiting examples of maintaining non-access-restricted database(s) and/or access-restricted database(s) and subsequently searching the non-access-restricted database(s) and/or the access-restricted database(s) in furtherance of satisfying a request, in accordance with various implementations.

FIG. 7 depicts an example architecture of a computing device, in accordance with various implementations.

### DETAILED DESCRIPTION

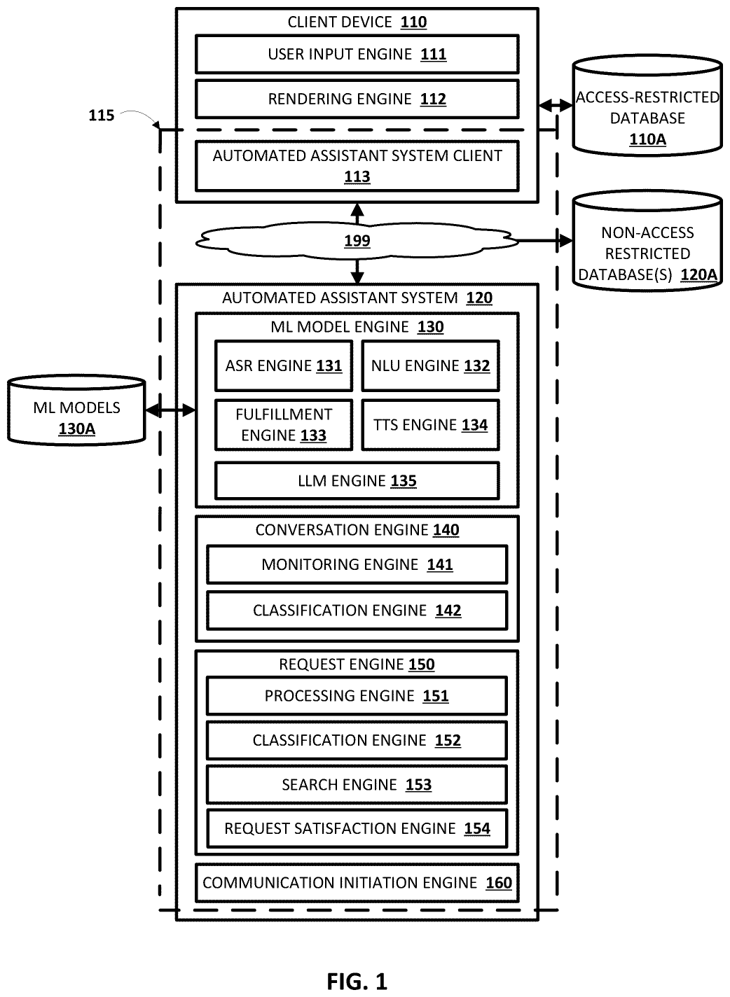

Turning now to FIG. 1, a block diagram of an example environment that demonstrates various aspects of the present disclosure, and in which implementations disclosed herein can be implemented is depicted. A client device 110 is illustrated in FIG. 1, and includes, in various implementations, a user input engine 111, a rendering engine 112, and an automated assistant system client 113. The client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device, etc.). Additional and/or alternative client devices may be provided.

The user input engine 111 can detect various types of user input at the client device 110. In some examples, the user input detected at the client device 110 can include spoken utterance(s) of a human user of the client device 110 that is detected via microphone(s) of the client device 110. In these examples, the microphone(s) of the client device 110 can generate audio data that captures the spoken utterance(s). In other examples, the user input detected at the client device 110 can include touch input of a human user of the client device 110 that is detected via user interface input device(s) (e.g., touch sensitive display(s)) of the client device 110, and/or typed input detected via user interface input device(s) (e.g., touch sensitive display(s) and/or keyboard(s)) of the client device 110. In these examples, the user interface input device(s) of the client device 110 can generate textual data that captures the touch input and/or the typed input.

The rendering engine 112 can cause content and/or other output to be visually rendered for presentation to the user at the client device 110 (e.g., via a touch sensitive display or other user interface output device(s)) and/or audibly rendered for presentation to the user at the client device 110 (e.g., via speaker(s) or other user interface output device(s)). The content and/or other output can include, for example, a transcript of a conversation between a user of the client device 110 and an automated assistant 115 executing at least in part at the client device 110, a transcript of a conversation between the automated assistant 115 executing at least in part at the client device 110 and an additional user that is in addition to the user of the client device 110, a transcript of a conversation between a user of the client device 110 and an additional user that is in addition to the user of the client device 110, notifications, selectable graphical elements, and/or any other content and/or output described herein.

Further, the client device 110 is illustrated in FIG. 1 as communicatively coupled, over one or more networks 199 (e.g., any combination of Wi-Fi®, Bluetooth®, or other local area networks (LANs); ethernet, the Internet, or other wide area networks (WANs); and/or other networks), to an automated assistant system 120 implemented remotely from the client device 110. The automated assistant system 120 can be implemented by, for example, a high-performance server, a cluster of high-performance servers, and/or any other computing device that is remote from the client device 110. The automated assistant system 120 includes, in various implementations, a machine learning (ML) model engine 130, a conversation engine 140, a request engine 150, and a communication initiation engine 160. The ML model engine 130 can include various sub-engines, such as an automatic speech recognition (ASR) engine 131, a natural language understanding (NLU) engine 132, a fulfillment engine 133, a text-to-speech (TTS) engine 134, and a large language model (LLM) engine 135. These various sub-engines can utilize one or more respective ML models (e.g., stored in ML models database 130A). Further, the conversation engine 140 can include various sub-engines, such as a monitoring engine 141 and a classification engine 142. Moreover, the request engine 150 can include various sub-engines, such as a processing engine 151, a classification engine 152, a search engine 153, and a request satisfaction engine 154.

The automated assistant system 120 can leverage various databases. For instance, and as noted above, the ML model engine 130 can the leverage ML models database 130A that stores various ML models; the client device 110 can leverage access-restricted database 110A; and the client device 110 and/or the automated assistant system 120 can leverage non-access-restricted database(s). Although FIG. 1 is depicted with respect to certain components having access to certain databases, it should be understood that is for the sake of example and is not meant to be limiting.

Moreover, the client device 110 can execute the automated assistant system client 113. An instance of the automated assistant system client 113 can be an application that is separate from an operating system of the client device 110 (e.g., installed “on top” of the operating system)—or can alternatively be implemented directly by the operating system of the client device 110. The automated assistant system client 113 can communicate with the automated assistant system 120 via one or more of the networks 199 (e.g., as shown in FIG. 1). The automated assistant system client 113 (and optionally by way of its interactions with the automated assistant system 120) may form what appears to be, from a user's perspective, a logical instance of an automated assistant 115. An instance of the automated assistant 115 is depicted in FIG. 1, and is encompassed by a dashed line that includes the automated assistant system client 113 of the client device 110 and the automated assistant system 120. However, it should be understood that the automated assistant system client 113 can implement the automated assistant system 120 locally at the client device 110, thereby resulting in the automated assistant 115 being implemented locally at the client device 110.

Furthermore, the client device 110 and/or the automated telephone call system 120 may include one or more memories for storage of data and software applications, one or more processors for accessing data and executing the software applications, and other components that facilitate communication over one or more of the networks 199. In some implementations, one or more of the software applications can be installed locally at the client device 110, whereas in other implementations one or more of the software applications can be hosted remotely from the client device 110 (e.g., by one or more servers), but accessible by the client device 110 over one or more of the networks 199.

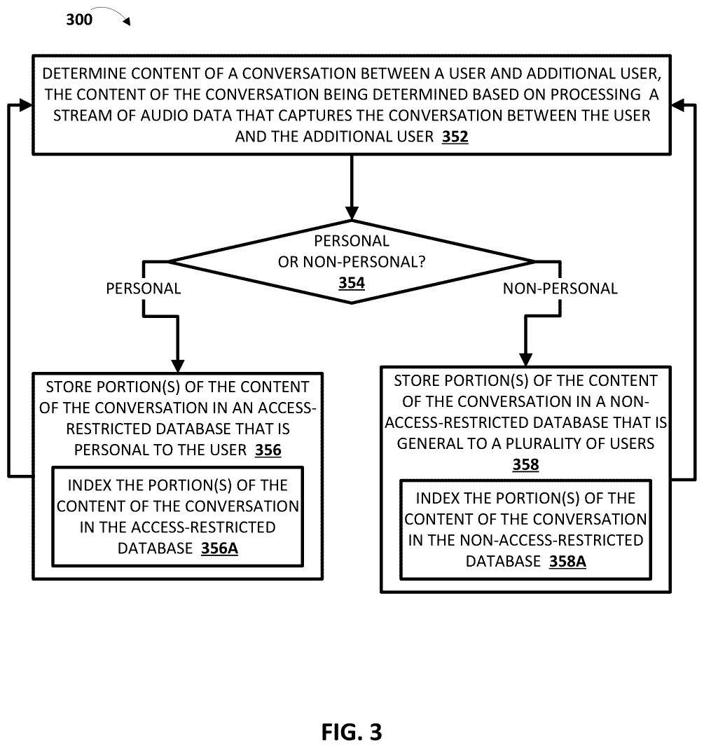

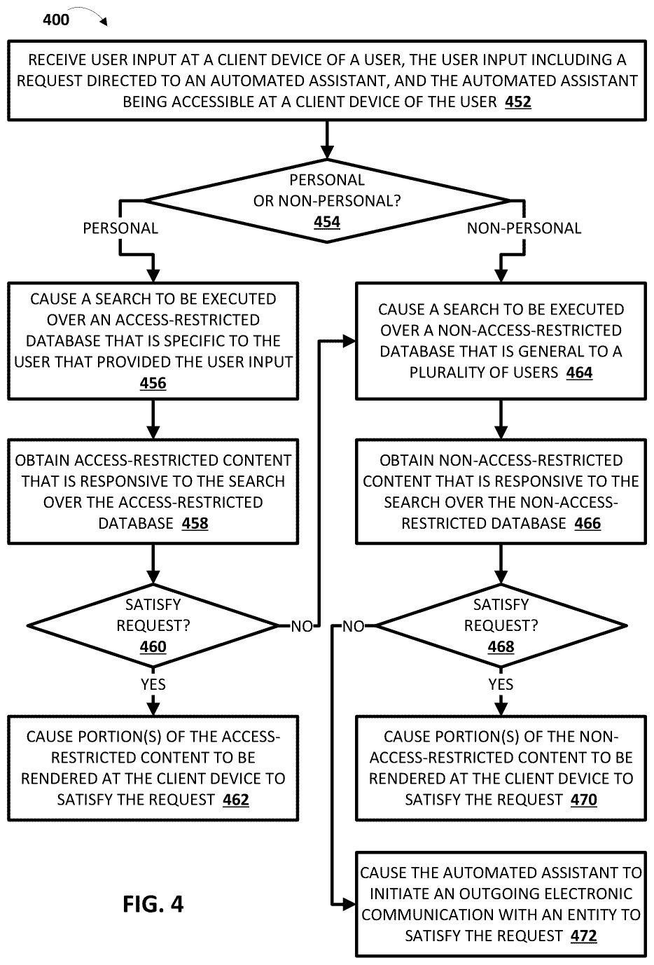

As described herein, the automated assistant system 120 can be utilized to maintain the access-restricted database 110A that is specific to the user of the client device 110 and to maintain the non-access-restricted database(s) 120A that is/are general to a plurality of users, including the user of the client device 110 and additional users (e.g., as described with respect to FIG. 3). The access-restricted database 110A and the non-access-restricted database(s) 120A can each include content from conversations that are processed by the automated assistant 115. By maintaining the access-restricted database 110A and the non-access-restricted database(s) 120A, the automated assistant 115 can selectively access the access-restricted database 110A and the non-access-restricted database(s) 120A in responding to requests provided by the user of the client device 110 (e.g., as described with respect to FIG. 4). Put another way, the automated assistant 115 can selectively access the access-restricted database 110A and the non-access-restricted database(s) 120A to obtain content stored therein that is responsive to the requests provided by the user, thereby mitigating and/or eliminating the need to initiate outgoing electronic communications to conduct additional conversations to satisfy the requests provided by the user in situations where the content stored therein is sufficient to satisfy the requests provided by the user.

The conversations described herein can be between the user of the client device 110 and one or more additional users, between the user of the client device 110 and the automated assistant 115, between the user of the client device 110 and an additional automated assistant (e.g., that is in addition to the automated assistant 115), between the automated assistant 115 and one or more additional users, between the automated assistant 115 and an additional automated assistant, and so on. For example, the conversations can be performed during telephone calls conducted using Voice over Internet Protocol (VoIP), public switched telephone networks (PSTN), and/or other telephonic communication protocols. As another example, the conversations can be conducted in-person. Notably, microphone(s) of the client device 110 or additional microphone(s) of additional client device(s) can generate a stream of audio data that captures the conversation, and the stream of audio data can be processed to determine the content of the conversations (e.g., based on NLU output and/or LLM output).

In various implementations, the ASR engine 131 can process, using ASR model(s) stored in the ML models database 130A (e.g., a recurrent neural network (RNN) model, a transformer model, and/or any other type of ML model capable of performing ASR), audio data that captures a spoken utterance and that is generated by microphone(s) of the client device 110 (or microphone(s) of additional client device(s)) to generate ASR output. Further, the NLU engine 132 can process, using NLU model(s) stored in the ML models database 130A (e.g., a long short-term memory (LSTM), gated recurrent unit (GRU), and/or any other type of RNN or other ML model capable of performing NLU) and/or NLU rule(s), the ASR output (or other typed or touch inputs received via the user input engine 111 of the client device 110) to generate NLU output. Moreover, the fulfillment engine 133 can process, using fulfillment model(s) and/or fulfillment rules stored in the ML models database 130A, the NLU data to generate fulfillment output. Additionally, the TTS engine 134 can process, using TTS model(s) stored in the ML models database 130A, textual content (e.g., text formulated by the automated assistant 115) to generate synthesized speech audio data that includes computer-generated synthesized speech. Furthermore, in various implementations, the LLM engine 135 can replace one or more of the aforementioned components. For instance, the LLM engine 135 can replace the NLU engine 132 and/or the fulfillment engine 133. In these implementations, the LLM engine 135 can process, using LLM(s) stored in the ML models database 130A (e.g., Gemini, PaLM, BARD, BERT, LaMDA, Meena, GPT, and/or any other LLM, such as any other LLM that is encoder-only based, decoder-only based, sequence-to-sequence based and that optionally includes an attention mechanism or other memory), the ASR output (or other typed or touch inputs received via the user input engine 111 of the client device 110) to generate LLM output.

In various implementations, the ASR output can include, for example, a plurality of speech hypotheses (e.g., term hypotheses and/or transcription hypotheses) that are predicted to correspond to spoken utterance(s) based on the processing of audio data that captures the spoken utterance(s). The ASR engine 131 can optionally select a particular speech hypotheses as recognized text for the spoken utterance(s) based on a corresponding value associated with each of the plurality of speech hypotheses (e.g., probability values, log likelihood values, and/or other values). In various implementations, the ASR model(s) stored in the ML model(s) database 130A are end-to-end speech recognition model(s), such that the ASR engine 131 can generate the plurality of speech hypotheses directly using the ASR model(s). For instance, the ASR model(s) can be end-to-end model(s) used to generate each of the plurality of speech hypotheses on a character-by-character basis (or other token-by-token basis). One non-limiting example of such end-to-end model(s) used to generate the recognized text on a character-by-character basis is a recurrent neural network transducer (RNN-T) model. An RNN-T model is a form of sequence-to-sequence model that does not employ attention mechanisms or other memory. In other implementations, the ASR model(s) are not end-to-end speech recognition model(s) such that the ASR engine 131 can instead generate predicted phoneme(s) (and/or other representations). For instance, the predicted phoneme(s) (and/or other representations) may then be utilized by the ASR engine 131 to determine a plurality of speech hypotheses that conform to the predicted phoneme(s). In doing so, the ASR engine 131 can optionally employ a decoding graph, a lexicon, and/or other resource(s).

In various implementations, the NLU output can include, for example, annotated recognized text that includes one or more annotations of the recognized text for one or more (e.g., all) of the terms of the recognized text. For example, the NLU engine 132 may include a part of speech tagger (not depicted) configured to annotate terms with their grammatical roles. Additionally, or alternatively, the NLU engine 132 may include an entity tagger (not depicted) configured to annotate entity references in one or more segments of the recognized text, such as references to people (including, for instance, literary characters, celebrities, public figures, etc.), organizations, locations (real and imaginary), and so forth. In some implementations, data about entities may be stored in one or more databases, such as in a knowledge graph (not depicted). In some implementations, the knowledge graph may include nodes that represent known entities (and in some cases, entity attributes), as well as edges that connect the nodes and represent relationships between the entities. The entity tagger may annotate references to an entity at a high level of granularity (e.g., to enable identification of all references to an entity class such as people) and/or a lower level of granularity (e.g., to enable identification of all references to a particular entity such as a particular person). The entity tagger may rely on content of the natural language input to resolve a particular entity and/or may optionally communicate with a knowledge graph or other entity database to resolve a particular entity. Additionally, or alternatively, the NLU engine 132 may include a coreference resolver (not depicted) configured to group, or “cluster,” references to the same entity based on one or more contextual cues. For example, the coreference resolver may be utilized to resolve the term “them” to “buy theatre tickets” in the natural language input “buy them”, based on “theatre tickets” being mentioned in a client device notification rendered immediately prior to receiving input “buy them”. In some implementations, one or more components of the NLU engine 132 may rely on annotations from one or more other components of the NLU engine 132. For example, in some implementations, the entity tagger may rely on annotations from the coreference resolver in annotating all mentions to a particular entity. Also, for example, in some implementations, the coreference resolver may rely on annotations from the entity tagger in clustering references to the same entity. Also, for example, in some implementations, the coreference resolver may rely on user data of the user of the client device 110 in coreference resolution and/or entity resolution. The user data may include, for example, historical location data, historical temporal data, user preference data, user account data, calendar information, email data, and/or any other user data that is accessible at the client device 110.

In various implementations, the fulfillment output can include, for example, one or more tasks to be performed by the automated assistant 115 and in furtherance of a request provided by the user. For example, the user can provide unstructured free-form natural language input in the form of spoken utterance(s) or typed input(s) and that includes the request. The spoken utterance(s) can include, for instance, an explicit or implicit indication of the one or more tasks to be performed by the automated assistant 115 to satisfy the request. The one or more tasks may require the automated assistant 115 to provide certain information to the user, engage with one or more external systems on behalf of the user (e.g., an inventory system, a reservation system, etc. via a remote procedure call (RPC)), initiate an outgoing electronic communication on behalf of the user of the client device 110, and/or any other task that may be specified by the user and performed by the automated assistant 115. Accordingly, it should be understood that the fulfillment output may be based on the one or more tasks to be performed by the automated assistant 115 and may be dependent on the request provided by the user.

In various implementations, the TTS engine 134 can generate synthesized speech audio data that captures computer-generated synthesized speech. The synthesized speech audio data can be rendered at the client device 110 via speaker(s) of the client device 110 and/or other client devices described herein. The synthesized speech may include any output generated by the automated assistant 115 as described herein, and may include, for example, synthesized speech generated as part of a dialog between the user of the client device 110 and the automated assistant 115, as part of an automated telephone call between the automated assistant 115 and a representative associated with an entity (e.g., a human representative associated with the entity, an automated assistant representative associated with the entity, and interactive voice response (IVR) system associated with the entity, etc.), and so on.

In various implementations, the LLM output can include, for example, a probability distribution over a sequence of tokens, such as words, phrases, or other semantic units, that are predicted to be responsive to the spoken utterance(s) or other user inputs provided by the user of the client device 110 and/or other users (e.g., a human representative associated with an entity, an automated assistant associated with an entity, etc.). Notably, the LLM(s) stored in the ML model(s) database 130A can include billions of weights and/or parameters that are learned through training the LLM on enormous amounts of diverse data. This enables these LLM(s) to generate the LLM output as the probability distribution over the sequence of tokens. In these implementations, the LLM engine 135 can replace the NLU engine 132 and/or the fulfillment engine 133 since these LLM(s) can perform the same or similar functionality in terms of natural language processing.

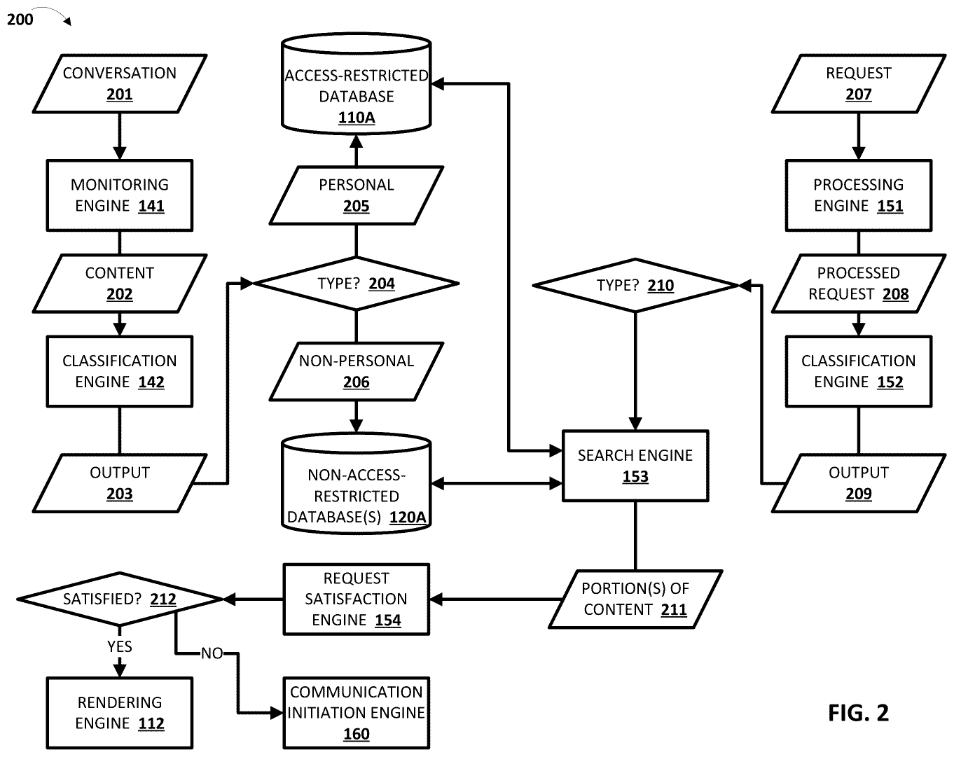

Although FIG. 1 is described with respect to a single client device having a single user, it should be understood that is for the sake of example and is not meant to be limiting. For example, one or more additional client devices of a user can also implement the techniques described herein. For instance, the client device 110, the one or more additional client devices, and/or any other computing devices of the user can form an ecosystem of devices that can employ techniques described herein. These additional client devices and/or computing devices may be in communication with the client device 110 and/or the automated assistant system 120 (e.g., over the one or more networks 199). As another example, a given client device can be utilized by multiple users in a shared setting (e.g., a group of users, a household, etc.). Additional description of the conversation engine 140, the request engine 150, and the communication initiation engine 160 is provided herein (e.g., with respect to FIGS. 2, 3, 4, 5A-5D, and 6A-6B).

Referring now to FIG. 2, an example process flow 200 for utilizing various components from the example environment of FIG. 1 is depicted. For the sake of example, assume that the user of the client device 110 and an additional user of an additional client device are engaged in a conversation 201 during a telephone call via the client device 110 and the additional client device. In this example, the monitoring engine 141 can process a stream of audio data that captures the conversation 201 between the user and the additional user to determine content 202 of the conversation 201. For instance, the monitoring engine 141 can process, using ASR model(s), the stream of audio data that captures the conversation 201 to generate ASR output for the conversation 201. Further, the monitoring engine 141 can process, using additional ML model(s) (e.g., NLU model(s), fulfillment model(s) or rule(s), LLM(s), etc.), the ASR output for the conversation 201 to generate output (e.g., NLU output, fulfillment output, LLM output, etc. and/or other output determined based on the NLU output, the fulfillment output, the LLM output, etc.), and determine the content 202 of the conversation 201 based on the output.

Although the above example is described with respect to monitoring the conversation as it occurs (e.g., in a synchronous manner), it should be understood that is for the sake of example and is not meant to be limiting. In additional or alternative implementations, the monitoring engine 141 can process streams of audio data capturing corresponding conversations (or transcriptions thereof) that previously occurred (e.g., in an asynchronous manner). In these implementations, the streams of audio data capturing the corresponding conversations can be obtained from a database of conversations. The database of conversations can be specific to the user and/or the additional user, or general to a population of users.

Further, the classification engine 142 can process the content 202 of the conversation 201 to generate output 203 and determine, based on the output 203 a type of the content 202 of the conversation 201 as indicated by 204. Notably, the type of the content 202 of the conversation 201 can be personal content 205 and/or non-personal content 206. In some implementations, and in generating the output 203, the classification engine 142 can process, using one or more classification ML models or classification rules (e.g., that are learned or heuristically defined), the content 202 of the conversation 202 to generate the output 203. The one or more classification ML models can be previously trained to determine, based on the content 202 of the conversation 201, whether one or more portions of the content are personal content or non-personal content. For instance, the classification engine 142 can process, using the one or more classification ML models, the NLU output, the fulfillment output, the LLM output and/or the content 202 of the conversation 201 determined based on the NLU output, the fulfillment output, the LLM output to generate numerical measures as the output 203. The numerical measures can include binary values that predict whether the content 202 of the conversation 201 is predicted to be personal content 205 or non-personal content 205, or non-binary values (e.g., probabilities, log likelihoods, etc.) that predict an extent to which the content 202 of the conversation 201 is predicted to be personal content 205 or non-personal content 205.

In additional or alternative implementations, and in generating the output 203, the classification engine 142 can determine a relationship between the user and the additional user. For instance, if the additional user is considered a personal entity with respect to the user of the client device 110, then the output 203 may indicate that the content 202 of the conversation 201 is personal content 205. In this instance, the additional user may be considered a personal entity with respect to the user of the client device 110 if the additional user is a family entity (e.g., a spouse, a sibling, a parent, a child, etc.), a friend entity, a co-worker entity, etc. Otherwise, the output 203 may indicate that the content 202 of the conversation 201 is non-personal content 206.

In implementations where the classification engine 142 determines that one or more portions of the content 202 of the conversation 201 corresponds to personal content 205, the one or more portions of the content 202 can be stored in the access-restricted database 110A that is specific to the user of the client device 110. In some versions of those implementations, the one or more portions of the content 202 that are determined to correspond to personal content 205 can be indexed and/or stored in association with metadata and based on the conversation 201. For instance, the one or more portions of the content 202 can be stored in association with participants in the conversation 201 (e.g., the user and the additional user in the above example) and/or entity types of the participants in the conversation 201, stored in association with topic(s) of the one or more portions of the content 202, stored in association with a day and/or time of the conversation 201, stored in association with a location of the user and/or the additional user participating in the conversation 201, and/or any other data that enables the automated assistant 115 to quickly and efficiently execute search(es) over the access-restricted database 110A.

However, in implementations where the classification engine 142 determines that one or more portions of the content 202 of the conversation 201 corresponds to non-personal content 206, the one or more portions of the content 202 can be stored in the non-access-restricted database(s) 120A that is general to the plurality of users, including the user of the client device 110, the additional user of the additional client device, and further additional users. In some versions of those implementations, the one or more portions of the content 202 that are determined to correspond to non-personal content 206 can be indexed and/or stored in association with metadata and based on the conversation 201. For instance, the one or more portions of the content 202 can be stored in association with participants in the conversation 201 (e.g., the user and the additional user in the above example) and/or entity types of the participants in the conversation 201, stored in association with topic(s) of the one or more portions of the content 202, stored in association with a day and/or time of the conversation 201, stored in association with a location of the user and/or the additional user participating in the conversation 201, and/or any other data that enables the automated assistant 115 to quickly and efficiently execute search(es) over the non-access-restricted database(s) 120A.

In additional or alternative versions of those implementations, the one or more portions of the content 202 can be stored in a given non-access-restricted database, from among the non-access-restricted database(s) 120A, that is specific to the additional user (or an entity associated with the additional user), but that is accessible by the plurality of users. In some versions of those implementations, the one or more portions of the content 202 that are determined to correspond to non-personal content 206 can be indexed and/or stored in association with metadata and based on the conversation 201 and in the same or similar manner described above. However, by storing the one or more portions of the content 202 that are determined to correspond to non-personal content 206 in the given non-access restricted database (and opposed to a single, general non-access-restricted database), a search space over which the automated assistant 115 execute search(es) over can be constrained, thereby resulting in a quicker and more efficient search.

For the sake of example, further assume that the user of the client device 110 directed a request 207 to the automated assistant 115 that is accessible at least in part at the client device 110. In this example, the processing engine 151 can process the request 207 to generate a processed request 208. Notably, the request 207 provided by the user of the client device 110 may be in free-form natural language input that is captured in spoken utterance(s), typed input(s), etc. Accordingly, in processing the request 207, the processing engine 151 can utilize various ML model(s) stored in the ML model(s) database 130A to generate the processed request 208. For instance, assume that the request 207 provided by the user of the client device 110 is a spoken utterance of “call Example Lawn Mower shop and see if they sell parts for Hypothetical Lawn Mower 3000”. In this example, the processing engine 151 can process, using ASR model(s), audio data that captures the spoken utterance to generate ASR output, such as recognized text corresponding to the spoken utterance. Further, the processing engine 151 can process, using NLU model(s), the ASR output to generate NLU output, such as annotated recognized text. In this example, the processing engine 151 can generate the processed request 208 based on the annotated recognized text. Additionally, or alternatively, the processing engine 151 can process, using LLM(s), the ASR output to generate LLM output, such as a natural language response that is responsive to the request 207. In this example, the processing engine 151 can generate the processed request 208 based on the natural language response that is responsive to the request 207. Accordingly, in these examples, the processed request can be for example, <intent=call [entity]>, where a slot value for an [entity] parameter is “Example Lawn Mower”, and <intent=inquire about availability of [product]>, where a slot value for an [product] parameter is “parts for Hypothetical Lawn Mower 3000”.

Further, the classification engine 152 can process the processed request 208 to generate output 209 and determine a type of the request 207 based on the output 209 as indicated at 210. Notably, the type of the request 207 may correspond to a personal request or a non-personal request. In processing the processed request 208, the classification engine 152 can utilize classification ML model(s) (e.g., in the same or similar manner described above with respect to the classification engine 142 in generating the output 203), relationship(s) between the user that provided the request 207 and one or more entities referenced in the request 207 (e.g., in the same or similar manner described above with respect to the classification engine 142 in generating the output 203), and/or other techniques in generating the output 209.

Moreover, and prior to initiating any outgoing electronic communication as specified by the user of the client device 110 in the request 207, the search engine 153 can cause a search to executed over the access-restricted database 110A and/or the non-access-restricted database(s) 120A to determine whether portion(s) of content 211 included in the access-restricted database 110A and/or the non-access-restricted database(s) 120A can be utilized to satisfy the request, thereby obviating the need to initiate the outgoing electronic communication. Whether the search engine 153 causes a search to be executed over the access-restricted database 110A and/or the non-access-restricted database(s) 120A is based on the type of the request determined based on the output 209.

For instance, if the type of the request 207 is a personal request, then the search engine 153 can generate a personal search query to be executed over the access-restricted database 110A and based on the processed request 208, and cause the automated assistant 115 to execute the personal search query over the access-restricted database 110A. Based on the personal search query being executed over the access-restricted database 110A, the search engine 153 can obtain the portion(s) of content 211 from the access-restricted database 110A. However, if the type of the request 207 is a non-personal request, then the search engine 153 can generate a non-personal search query to be executed over the non-access-restricted database(s) 120A and based on the processed request 208, and cause the automated assistant 115 to execute the non-personal search query over the non-access-restricted database(s) 120A. Based on the non-personal search query being executed over the non-access-restricted database(s) 120A, the search engine 153 can obtain the portion(s) of content 211 from the non-access-restricted database(s) 110A.

Continuing with the above example where the user of the client device 110 provided the request 207 of “call Example Lawn Mower shop and see if they sell parts for Hypothetical Lawn Mower 3000”, the output 209 would indicate that the request 207 is a non-personal request based on, for example, the request 207 being about parts for a lawn mower, the request 207 referencing a non-personal entity (e.g., a business entity (“Example Lawn Mower shop”) that is not a family entity, friend entity, co-worker entity, or other type of personal entity), and/or based on other considerations associated with the request 207. Accordingly, search engine 153 can cause the automated assistant 115 to execute the non-personal search over the non-access-restricted databases) 120A to obtain the portion(s) of content 211. Based on the portion(s) of content 211 that are obtained, the request satisfaction engine 154 can determine whether “Example Lawn Mower shop” does or does not “sell parts for Hypothetical Lawn Mower 3000”.

Assuming that the request satisfaction engine 154 determines that the portion(s) of content 211 indicate whether “Example Lawn Mower shop” does or does not “sell parts for Hypothetical Lawn Mower 3000”, the portion(s) of content 211 can be provided to the rendering 112 to cause portion(s) of content 211 to be provided for presentation to the user of the client device (e.g., as indicated at 212). However, assuming that the request satisfaction engine 154 determines that the portion(s) of content 211 do not indicate whether “Example Lawn Mower shop” does or does not “sell parts for Hypothetical Lawn Mower 3000”, the request satisfaction engine 154 can then instruct the communication initiation engine 160 to cause the automated assistant 115 to initiate and conduct an automated telephone call with “Example Lawn Mower shop” to determine whether they “sell parts for Hypothetical Lawn Mower 3000” to satisfy the request 207.

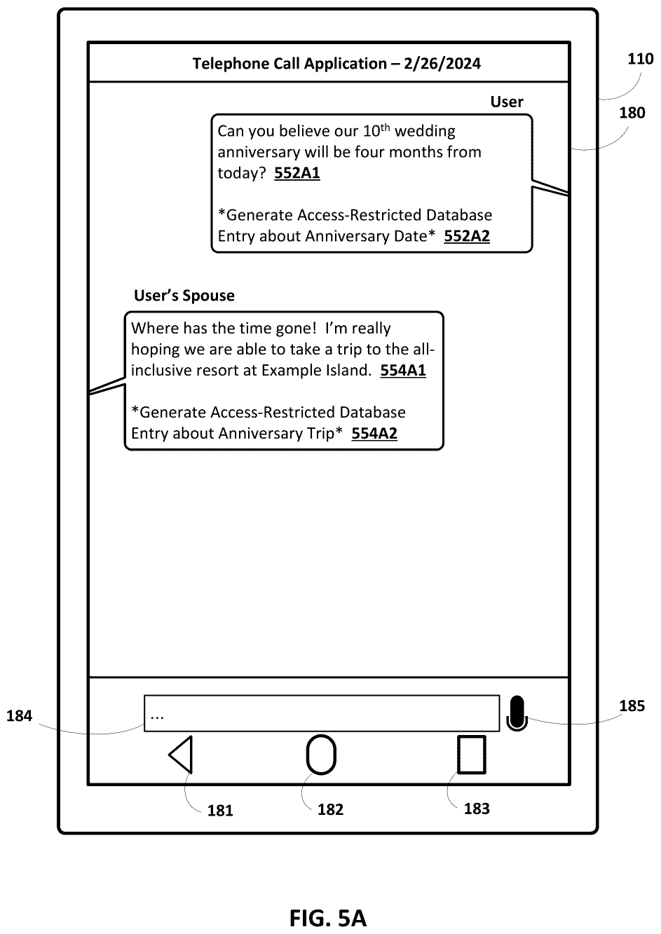

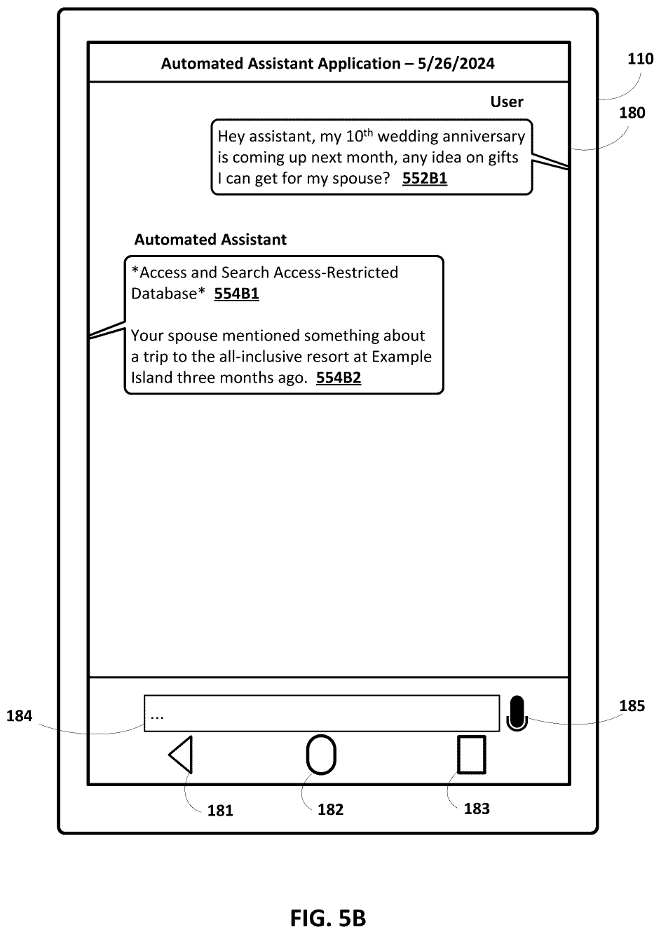

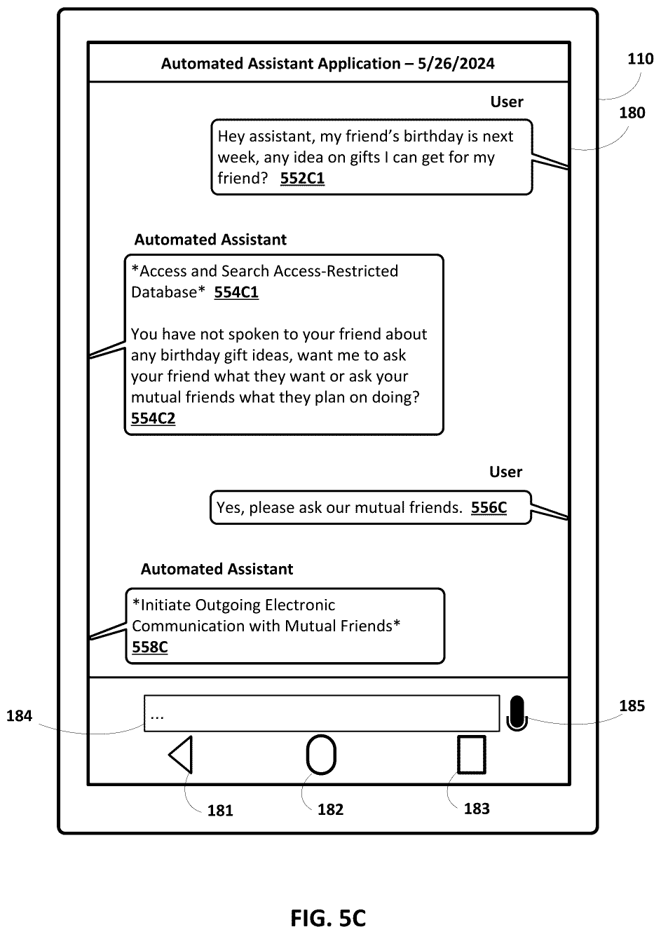

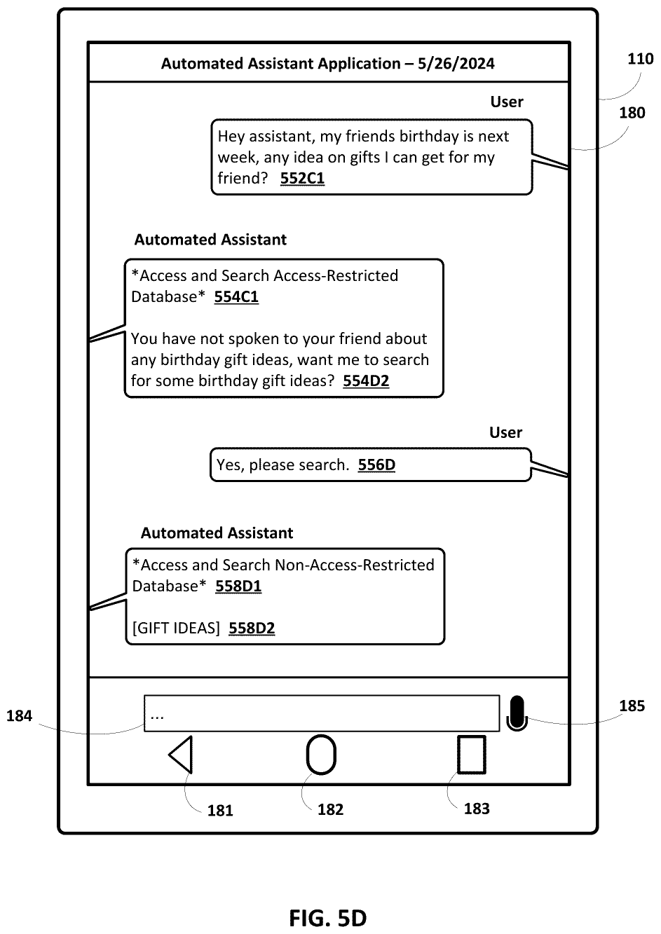

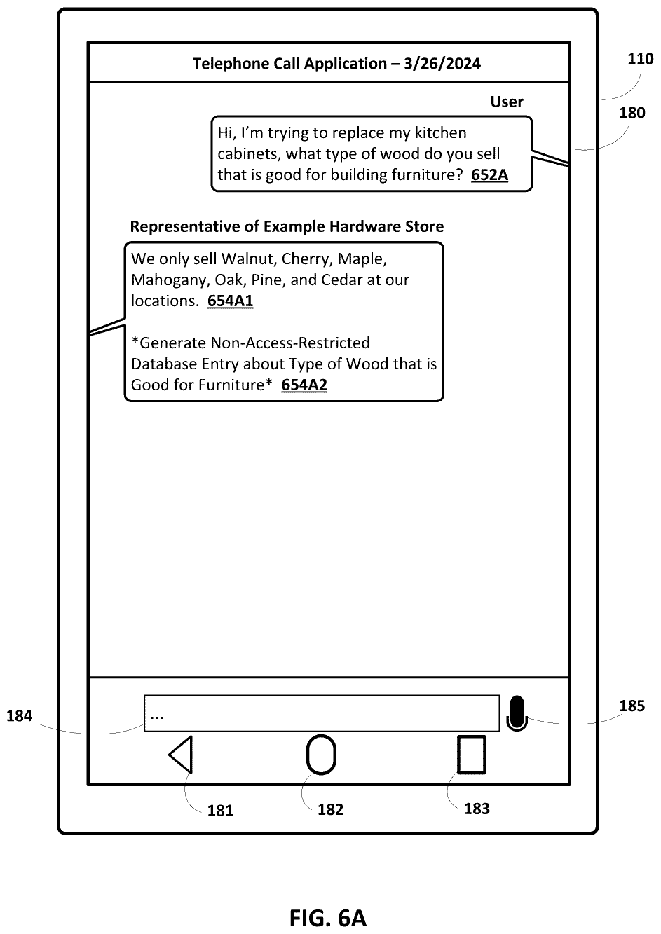

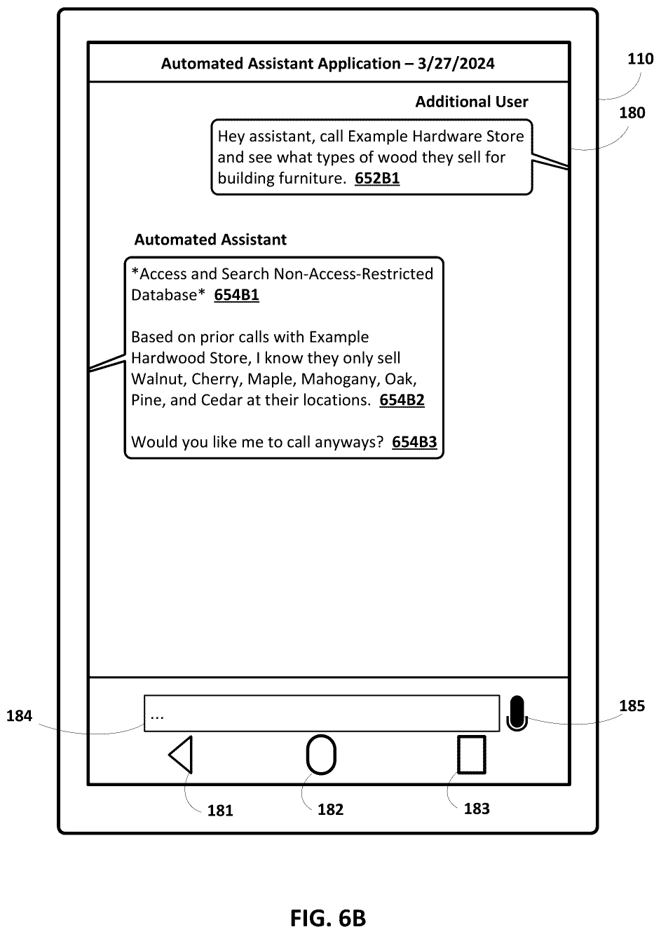

Although the above process flow 200 is described with respect to monitoring the conversation 201 between the user and the additional user, it should be noted that consent from any users for which content may be stored in the access-restricted database 110A and/or the non-access restricted database(s) 120A can be required. Further, consent from any users for which content may be stored in the access-restricted database 110A and/or the non-access restricted database(s) 120A can be dynamically adapted based on settings, for example, in an automated assistant software application that is accessible at respective client devices. Further, although the conversation 201 is described as being a telephonic conversation between the user and the additional user, it should be understood that is for the sake of example and is not meant to be limiting. Various other types of conversations that can be monitored to maintain the access-restricted database 110A and/or the non-access restricted database(s) 120A are contemplated herein. Moreover, although particular examples are described above with respect to the process flow 200 of FIG. 2, it should be understood that those examples are provided to illustrate some of the techniques described herein and that additional examples are provided here (e.g., with respect to FIGS. 5A-5D and 6A-6B).

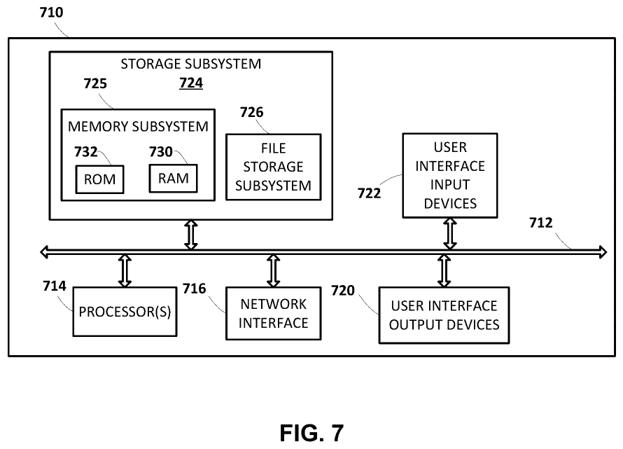

Turning now to FIG. 3, a flowchart illustrating an example method 300 of maintaining non-access-restricted database(s) and access-restricted database(s) is depicted. For convenience, the operations of the method 300 are described with reference to a system that performs the operations. This system of the method 300 includes at least one processor, memory, and/or other component(s) of computing device(s) (e.g., client device 110 of FIGS. 1, 5A-5D, and 6A-6B, automated assistant system 120 of FIG. 1, computing device 710 of FIG. 7, and/or other computing devices). Moreover, while operations of the method 300 are shown in a particular order, this is not meant to be limiting. One or more operations may be reordered, omitted, and/or added.

At block 352, the system determines content of a conversation between a user and an additional user, the content of the conversation being determined based on processing a stream of audio data that captures the conversation between the user and the additional user. Although block 352 indicates that the conversation is between the user and the additional user, it should be understood that is for illustrating techniques described herein and is not meant to be limiting. For instance, the conversation can be between the user an automated assistant associated with the user, between the user and an additional automated assistant (e.g., that is in addition to the automated assistant associated with the user), between the automated assistant that is associated with the user and the additional user, between the automated assistant that is associated with the user and the additional automated assistant, and so on. Further, the conversation can be performed during a telephone call, a video call, in-person, and/or in other environments. Moreover, the content of the conversation can be determined using various ML models described herein (e.g., as described with respect to the monitoring engine 141 of FIGS. 1 and 2).

At block 354, the system determines whether one or more portions of the content of the conversation is personal content or non-personal content. The system can determine whether one or more of the portions of the content of the conversation is personal content or non-personal content in the same or similar manner as described herein (e.g., with respect to the monitoring engine 141 and the classification engine 142 of FIGS. 1 and 2)

If, at an iteration of block 354, the system determines that one or more of the portions of the content is personal content, the system proceeds to block 356. At block 356, the system stores the one or more portions of the content that are personal content in an access-restricted database that is specific to the user. At sub-block 356A, the system indexes the one or more portions of the content that are personal content in the access-restricted database (e.g., as described with respect to the process flow 200 of FIG. 2). Put another way, in response to determining that one or more of the portions of the content is personal content (e.g., that is personal to the user and/or the additional user), the system can store the one or more portions of the content that are personal content in the access-restricted database that is not accessible to other users. The system returns to block 352 to continue determining the content of the conversation and/or additional content of an additional conversation between the user and the additional user (or a further additional user).

If, at an iteration of block 354, the system determines that one or more of the portions of the content is non-personal content, the system proceeds to block 358. At block 358, the system stores the one or more portions of the content that are non-personal content in a non-access-restricted database that is general to a plurality of users. At sub-block 358A, the system indexes the one or more portions of the content that are non-personal content in the non-access-restricted database (e.g., as described with respect to the process flow 200 of FIG. 2). Put another way, in response to determining that one or more of the portions of the content is non-personal content (e.g., that is not personal to the user and that is not personal to the additional user), the system can store the one or more portions of the content that are non-personal content in the non-access-restricted database that is accessible to other users. The system returns to block 352 to continue determining the content of the conversation and/or additional content of an additional conversation between the user and the additional user (or a further additional user).

Turning now to FIG. 4, a flowchart illustrating an example method 400 of searching non-access-restricted database(s) and access-restricted database(s) in furtherance of satisfying a request is depicted. For convenience, the operations of the method 400 are described with reference to a system that performs the operations. This system of the method 400 includes at least one processor, memory, and/or other component(s) of computing device(s) (e.g., client device 110 of FIGS. 1, 5A-5D, and 6A-6B, automated assistant system 120 of FIG. 1, computing device 710 of FIG. 7, and/or other computing devices). Moreover, while operations of the method 400 are shown in a particular order, this is not meant to be limiting. One or more operations may be reordered, omitted, and/or added.

At block 452, the system receives user input at a client device of a user, the user input including a request directed to an automated assistant, and the automated assistant being accessible at the client device of the user. The request can be provided, for example, as free-from natural language input via spoken utterance(s), typed input(s), and/or by other means of the user interacting with the automated assistant. In various implementations, the request can explicitly request that the automated assistant initiate an outgoing electronic communication (e.g., an automated telephone call, an automated message, etc.) to complete a task on behalf of the user.

At block 454, the system determines whether the request is a personal request or a non-personal request. The system can determine whether the request is a personal request or a non-personal request in the same or similar manner as described herein (e.g., with respect to the processing engine 151 and the classification engine 152 of FIGS. 1 and 2).

If, at an iteration block 454, the system determines that the request is a personal request, then the system proceeds to block 456. At block 456, the system causes a search to be executed over an access-restricted database that is specific to the user that provided the user input. At block 458, the system obtains access-restricted content that is responsive to the search over the access-restricted database (e.g., as described with respect to the search engine 153 of FIGS. 1 and 2). In some implementations, and in causing the search to be executed over the access-restricted database that is specific to the user that provided the user input, the system may obtain a token, hash, or other unique identifier associated with the user that enables the system to access the access-restricted database.

At block 460, the system determines, based on the access-restricted content obtained responsive to the search of the access-restricted database, whether the request can be satisfied using one or more portions of the access-restricted content (e.g., as described with respect to the request satisfaction engine 154 of FIGS. 1 and 2). Notably, in implementations where the access-restricted database includes content that is, in fact, responsive to the search over the access-restricted database, the access-restricted content can include that content. Otherwise, in implementations where the access-restricted database does not include content that is, in fact, responsive to the search over the access-restricted database, the access-restricted content can include an indication of such. If, at an iteration of block 460, the system determines that the request cannot be satisfied using one or more portions of the access-restricted content, the system proceeds to block 464. The operations of block 464 are described in more detail below.

If, at an iteration of block 460, the system determines that the request can be satisfied using one or more portions of the access-restricted content, the system proceeds to block 462. At block 462, the system causes the one or more portions of the access-restricted content to be rendered at the client device to satisfy the request (e.g., as described with respect to the rendering engine 112 of FIGS. 1 and 2). In causing the one or more portions of the access-restricted content to be rendered at the client device, the system can cause the one or more portions to be visually rendered for presentation to the user via a display of the client device. Additionally, or alternatively, in causing the one or more portions of the access-restricted content to be rendered at the client device, the system can cause the one or more portions to be audibly rendered for presentation to the user via speaker(s) of the client device.

If, at an iteration of block 454, the system determines that the request is a personal request, then the system proceeds to block 464. At block 464, the system causes a search to be executed over a non-access-restricted database that is general to a plurality of users (e.g., as described with respect to the search engine 153 of FIGS. 1 and 2). At block 466, the system obtains non-access-restricted content that is responsive to the search over the non-access-restricted database. Notably, no token, hash, or other unique identifier associated with the user may be required to enable the system to access the non-access-restricted database.

At block 468, the system determines, based on the non-access-restricted content obtained responsive to the search of the non-access-restricted database, whether the request can be satisfied using one or more portions of the non-access-restricted content (e.g., as described with respect to the request satisfaction engine 154 of FIGS. 1 and 2).

If, at an iteration of block 468, the system determines that the request can be satisfied using one or more portions of the non-access-restricted content, the system proceeds to block 470. At block 470, the system causes the one or more portions of the non-access-restricted content to be rendered at the client device to satisfy the request (e.g., as described with respect to the rendering engine 112 of FIGS. 1 and 2). In causing the one or more portions of the non-access-restricted content to be rendered at the client device, the system can cause the one or more portions to be visually rendered for presentation to the user via a display of the client device. Additionally, or alternatively, in causing the one or more portions of the non-access-restricted content to be rendered at the client device, the system can cause the one or more portions to be audibly rendered for presentation to the user via speaker(s) of the client device.

If, at an iteration of block 468, the system determines that the request cannot be satisfied using one or more portions of the non-access-restricted content, the system proceeds to block 472. At block 472, the system causes the automated assistant to initiate an outgoing electronic communication with an entity to satisfy the request. Notably, the request may specify a type of the outgoing electronic communication to be initiated to satisfy the request. Otherwise, the system may select the type of outgoing electronic communication with the entity to satisfy the request. Upon concluding a conversation based on the outgoing electronic communication that was initiated, the system can generate a notification to be provided for presentation to the user. The notification can include, for example, notification content that is responsive to the request and that is determined based on the conversation that was conducted subsequent to initiating the outgoing electronic communication.

Notably, the method 400 of FIG. 4 is described with respect to proceeding to block 464 from block 460. Put another way, in these implementations, when the system determines the access-restricted content obtained responsive to the search over the access-restricted database cannot be utilized to satisfy the request, the system may attempt to utilize non-access-restricted content obtained responsive to an additional search over the non-access-restricted database to satisfy the request. However, when the system determines the non-access-restricted content obtained responsive to the additional search over the non-access-restricted database cannot be utilized to satisfy the request, the system may then cause the automated assistant to initiate the outgoing electronic communication. Additionally, or alternatively, in these situations, the system may proceed from block 460 to block 472 and refrain from causing the additional search to be executed over the non-access-restricted database.

Although block 472 method 400 of FIG. 4 is described with respect to causing the automated assistant to initiate the outgoing electronic communication based on a single request received from a single user, it should be understood that is not meant to be limiting. For instance, in some implementations, the system may not cause the automated assistant to initiate the outgoing electronic communication with the entity to satisfy the request until a threshold quantity of instances of the request are received across a population of users, and optionally with the population of users being restricted to a particular geographical region. In this instance, the system effectively aggregates the request across the population of users and initiates a single outgoing electronic communication to satisfy the request on behalf of the population of users. Further, respective instances of the automated assistant can notify the population of users of a result of the outgoing electronic communication.

Turning now to FIGS. 5A-5D, various non-limiting examples of maintaining non-access-restricted database(s) and/or access-restricted database(s) and subsequently searching the non-access-restricted database(s) and/or the access-restricted database(s) in furtherance of satisfying a request are depicted. FIGS. 5A-5D each depict a client device 110 (e.g., an instance of the client device 110 from FIG. 1) having a display 180. Although the client device 110 of FIGS. 5A-5D is depicted as a mobile phone, it should be understood that is not meant to be limiting. The client device 110 can be, for example, a stand-alone assistant device (e.g., with speaker(s) and/or a display), a laptop, a desktop computer, a wearable computing device (e.g., a smart watch, smart headphones, etc.), a vehicular computing device, and/or any other client device capable of making telephonic calls.

The display 180 of the client device 110 in FIGS. 5A-5D further includes a textual input interface element 184 that the user may select to generate user input via a keyboard (virtual or real) or other touch and/or typed input, and a spoken input interface element 185 that the user may select to generate user input via microphone(s) of the client device 110. In some implementations, the user may generate user input via the microphone(s) without selection of the spoken input interface element 185. For example, active monitoring for audible user input via the microphone(s) may occur to obviate the need for the user to select the spoken input interface element 185. In some of those and/or in other implementations, the spoken input interface element 185 may be omitted. Moreover, in some implementations, the textual input interface element 184 may additionally and/or alternatively be omitted (e.g., the user may only provide audible user input). The display 180 of the client device 110 in FIGS. 5A-5D also includes system interface elements 181, 182, 183 that may be interacted with by the user to cause the client device 110 to perform one or more actions.

Referring specifically to FIG. 5A, for the sake of example assume that a user of the client device 110 is engaged in a telephone call with the user's spouse on Feb. 26, 2024, and further assume that an automated assistant is monitoring a conversation during the telephone call to maintain an access-restricted database that is specific to the user and non-access-restricted database(s) that is/are general to a population of users. Further assume that the user of the client device 110 provides a spoken utterance 552A1 of “Can you believe our 10th wedding anniversary will be four months from today?” In this example, and based on processing a stream of audio data that captures the spoken utterance 552A1, further assume that the automated assistant determines to generate an access-restricted database entry about the anniversary date for the user and the user's spouse as indicated by 552A2.

Notably, the automated assistant can determine to generate the access-restricted database entry about the anniversary date for the user and the user's spouse based on content in the spoken utterance 552A1 referencing a wedding anniversary date between two people (e.g., being Jun. 26, 2024), based on a relationship between the user and the user's spouse (e.g., being spouses), and/or based on other considerations. Accordingly, in this example and based on the spoken utterance 552A1, the automated assistant can generate the access-restricted database entry about the anniversary date for the user and the user's spouse and optionally store it in association with other metadata associated with the conversation to help index the access-restricted database entry.

Further assume that the user's spouse provides a spoken utterance 554A1 of “Where has the time gone! I'm really hoping we are able to take a trip to the all-inclusive resort at Example Island.” In this example, and based on processing a stream of audio data that captures the spoken utterance 554A1, further assume that the automated assistant determines to generate an access-restricted database entry about the user's spouse's desired anniversary trip destination indicated by 554A2. Notably, the automated assistant can determine to generate the access-restricted database entry about the user's spouse desired anniversary trip destination based on content in the spoken utterance 552A1 being referenced in the context of the wedding anniversary date between two people (e.g., being an anniversary trip to an all-inclusive resort at Example Island), based on a relationship between the user and the user's spouse (e.g., being spouses), and/or based on other considerations. Accordingly, in this example and based on the spoken utterance 554A1, the automated assistant can generate the access-restricted database entry about the anniversary date for the user and the user's spouse and optionally store it in association with other metadata associated with the conversation to help index the access-restricted database entry.

Referring specifically to FIG. 5B, for the sake of example assume that the user of the client device 110 directs a request on May 26, 2024 to the automated assistant via a spoken utterance 552B1 of “Hey assistant, my 10th wedding anniversary is coming up next month, any ideas on gifts I can get for my spouse?” In this example, and based on processing a stream of audio data that captures the spoken utterance 552B1, further assume that the automated assistant determines that the request included in the spoken utterance 552B1 is a personal request. Notably, the automated assistant can determine that the request is a personal request based on, for example, the request referencing a personal entity (e.g., “my spouse”) and/or based on the request referencing a personal event (e.g., “wedding anniversary”). Accordingly, in this example and based on the spoken utterance 552B1, the automated assistant can cause a search over an access-restricted database to be executed.

In the example of FIG. 5B, further assume that the automated assistant accesses and searches the access-restricted database that is specific to the user of the client device 110 to obtain access-restricted content as indicated by 554B1. Accordingly, in this example and based on the access-restricted content obtained responsive to the search (e.g., from the telephone call in FIG. 5A), the automated assistant can cause output 554B2 of “your spouse mentioned something about a trip to the all-inclusive resort at Example Island three months ago” to be visually and/or audibly rendered at the client device 110, thereby satisfying the request that was included in the spoken utterance 552B1. Put another way, the automated assistant can utilize content from a conversation that occurred three months prior to satisfy the request. However, the automated assistant may not always be able to content from prior conversations between users to satisfy the spoken utterance.

Referring specifically to FIG. 5C, for the sake of example assume that the user of the client device 110 directs a request on May 26, 2024 to the automated assistant via a spoken utterance 552C1 of “Hey assistant, my friend's birthday is next week, any idea on gifts I can get for my friend?” In this example, and based on processing a stream of audio data that captures the spoken utterance 552C1, further assume that the automated assistant determines that the request included in the spoken utterance 552C1 is a personal request. Notably, the automated assistant can determine that the request is a personal request based on, for example, the request referencing a personal entity (e.g., “my friend”) and/or based on the request referencing a personal event (e.g., “my friend's birthday”). Accordingly, in this example and based on the spoken utterance 552CB1, the automated assistant can cause a search over an access-restricted database to be executed.

In the example of FIG. 5C, further assume that the automated assistant accesses and searches the access-restricted database that is specific to the user of the client device to obtain access-restricted content as indicated by 554C1. However, in this example and based on the access-restricted content (or the lack thereof) obtained responsive to the search, the automated assistant can cause output 554C2 of “You have not spoken to your friend about any birthday gift ideas, want me to ask your friend what they want or ask your mutual friends what they plan on doing” to be visually and/or audibly rendered at the client device 110. Although the output 554BC does not satisfy the request that was included in the spoken utterance 552C1, the automated assistant still provides means for satisfying the request by causing a recommendation to initiate an outgoing electronic communication to satisfy the request to be provided for presentation to the user of the client device 110. Further assuming that the user provides an additional spoken utterance 556C of “Yes, please ask our mutual friends”, the automated assistant can then initiate an outgoing electronic communication with mutual friends of the user and the user's friend (e.g., by individual messages, to an existing group chat (less the user's friend with the upcoming birthday), or the like) as indicated by 558C.

Additionally, or alternatively, and referring specifically to FIG. 5D, rather than causing the recommendation to initiate the outgoing electronic communication to satisfy the request to be provided for presentation to the user of the client device 110 via the output 554C2, the automated assistant can cause output 554D2 of “You have not spoken to your friend about any birthday gift ideas, want me to search for some birthday gift ideas?” Further assuming that the user provides an additional spoken utterance 556D of “Yes, please search”, the automated assistant can then access and search non-access-restricted database(s) that is/are general to a plurality of users to obtain non-access-restricted content as indicated by 558D1, and cause non-access-restricted database content corresponding to gift ideas to be provided for presentation to the user of the client device 110 as output 558D2.

Turning now to FIGS. 6A-6B, various additional non-limiting examples of maintaining non-access-restricted database(s) and/or access-restricted database(s) and subsequently searching the non-access-restricted database(s) and/or the access-restricted database(s) in furtherance of satisfying a request are depicted. FIGS. 6A-6B each depict the client device 110 the display 180 from FIGS. 5A-5D along with the same interface elements 181, 182, 183, 184, and 185. Similar to FIGS. 5A-5D, although the client device 110 of FIGS. 5A-5D is depicted as a mobile phone, it should be understood that is not meant to be limiting.

Referring specifically to FIG. 6A, for the sake of example assume that a user of the client device 110 is engaged in a telephone call with a representative of Example Hardware store on Mar. 26, 2024, and further assume that an automated assistant is monitoring a conversation during the telephone call to maintain an access-restricted database that is specific to the user and non-access-restricted database(s) that is/are general to a population of users. Further assume that the user of the client device 110 provides a spoken utterance 652A of “Hi, I'm trying to replace my kitchen cabinets, what type of wood do you have that is good for building furniture?” In this example, and based on processing a stream of audio data that captures the spoken utterance 652A, further assume that the automated assistant determines not to generate an access-restricted database entry or a non-access-restricted database entry.

Further assume that the representative of Example Hardware Store provides a spoken utterance 654A1 of “We only sell Walnut, Cherry, Maple, Mahogany, Oak, Pine, and Cedar at our locations.” In this example, and based on processing a stream of audio data that captures the spoken utterance 654A1, further assume that the automated assistant determines to generate a non-access-restricted database entry about the types of wood sold by Example Hardware Store. Notably, the automated assistant can determine to generate the non-access-restricted database entry about the types of wood sold by Example Hardware Store based on content in the spoken utterance 654A1 being responsive to the initial question posed by the user of the client device 110, based on a relationship between the user and the representative of Example Hardware Store being non-personal, and/or based on other considerations. Accordingly, in this example and based on the spoken utterance 654A1, the automated assistant can generate the non-access-restricted database entry about the types of wood sold by Example Hardware Store and optionally store it in association with other metadata associated with the conversation to help index the non-access-restricted database entry.

Referring specifically to FIG. 6B, for the sake of example assume that an additional user of the client device 110 directs a request on Mar. 27, 2024 to the automated assistant (e.g., the user's spouse who is unaware of the telephone call placed to Example Hardware Store the day prior by the user in the example of FIG. 6A) via a spoken utterance 652B1 of “Hey assistant, call Example Hardware Store and see what types of wood they sell for building furniture.” In this example, and based on processing a stream of audio data that captures the spoken utterance 652B1, further assume that the automated assistant determines that the request included in the spoken utterance 652B1 is a non-personal request. Notably, the automated assistant can determine that the request is a non-personal request based on, for example, the request referencing a non-personal entity (e.g., “Example Hardware Store”) and/or based on the request referencing availability of a certain product (e.g., “types of wood” for sale). Accordingly, in this example and based on the spoken utterance 652B1, the automated assistant can cause a search over a non-access-restricted database to be executed.

In the example of FIG. 6B, further assume that the automated assistant accesses and searches the non-access-restricted database that is general to a plurality of users to obtain non-access-restricted content as indicated by 654B1. Accordingly, in this example and based on the non-access-restricted content obtained responsive to the search (e.g., from the telephone call in FIG. 6A), the automated assistant can cause output 654B2 of “Based on prior calls with Example Hardware Store, I know they only sell Walnut, Cherry, Maple, Mahogany, Oak, Pine, and Cedar at their locations” to be visually and/or audibly rendered at the client device 110, thereby satisfying the request that was included in the spoken utterance 652B1. Put another way, the automated assistant can utilize content from a conversation that occurred the prior day prior to satisfy the request. However, the automated assistant may still offer to call Example Hardware Store on behalf of the additional user as indicated by 654B3 if the additional user would like to verify this information.

Although transcriptions of the conversations are depicted throughout FIGS. 5A-5D and 6A-6B, it should be understood that is for the sake of brevity to illustrate various techniques contemplated herein and is not meant to be limiting. Rather, it should be understood that the conversations described herein can be voice-based conversations, text-based conversations, or a combination thereof. Further, although particular examples are described with respect to FIGS. 5A-5D and 6A-6B, it should be understood that they are provided for the sake of example and are not meant to be limiting. Rather, it should be understood that the content included in the access-restricted database and/or the non-access-restricted database(s) can be virtually limitless in that it is based on content of the conversations described herein.

Moreover, although the example of FIG. 6B is described with respect to the additional user using the same client device 110 to provide the request included in the spoken utterance 652B1, it should be understood that is for the sake of example and is not meant to be limiting. Rather, it should be understood that the additional user could provide the request via additional computing device(s) and that the additional user may have no relationship to the user that initially called Example Hardware Store in the example of FIG. 6A. Nonetheless, the automated assistant (or an additional instance of the automated assistant) can still utilize content stored in the non-access-restricted database in responding to the user in this scenario since the content is non-access-restricted content.

Turning now to FIG. 7, a block diagram of an example computing device 710 that may optionally be utilized to perform one or more aspects of techniques described herein. In some implementations, one or more of a client device, remote system component(s), and/or other component(s) may comprise one or more components of the example computing device 710.

Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touchscreen incorporated into the display (e.g., a touch sensitive display), audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the methods disclosed herein, as well as to implement various components depicted in FIGS. 1 and 2.

These software modules are generally executed by processor 714 alone or in combination with other processors. Memory 725 used in the storage subsystem 724 can include a number of memories including a main random-access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem 712 may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: receiving user input at a client device of a user, the user input including a request directed to an automated assistant, and the automated assistant being accessible at a client device of the user; determining, based on processing the request, whether the request is a personal request or a non-personal request; and in response to determining that the request is a personal request: causing an access-restricted search to be executed over an access-restricted database that is specific to the user that provided the user input; determining, based on access-restricted content obtained responsive to the access-restricted search over the access-restricted database that is personal to the user, whether the request can be satisfied using the access-restricted content; and in response to determining that the request can be satisfied using the access-restricted content: causing one or more portions of the access-restricted content to be rendered at the client device.

These and other implementations of technology disclosed herein can optionally include one or more of the following features.

In some implementations, the method may further include, in response to determining that the request cannot be satisfied using the access-restricted content: causing a search to be executed over a non-access-restricted database that is general to a plurality of users, the plurality of users including the user and additional users; determining, based on non-access-restricted content obtained responsive to the search over the non-access-restricted database that is general to the plurality of users, whether the request can be satisfied using the non-access-restricted content; and in response to determining that the request can be satisfied using the non-access-restricted content: causing one or more portions of the non-access-restricted content to be rendered at the client device.

In some versions of those implementations, the method may further include, in response to determining that the request cannot be satisfied using the non-access-restricted content: causing a recommendation to initiate an outgoing electronic communication to be rendered at the client device.

In some further versions of those implementations, the outgoing electronic communication may be one of: an automated telephone call that is initiated and conducted by the automated assistant and on behalf of the user, or an automated message that is generated and sent by the automated assistant and on behalf of the user.

In some implementations, the method may further include, in response to determining that the request cannot be satisfied using the access-restricted content: causing a recommendation to initiate an outgoing electronic communication to be rendered at the client device.

In some further versions of those implementations, the outgoing electronic communication may be one of: an automated telephone call that is initiated and conducted by the automated assistant and on behalf of the user, or an automated message that is generated and sent by the automated assistant and on behalf of the user.

In some implementations, the method may further include, in response to determining that the request is a non-personal request: causing a search to be executed over a non-access-restricted database that is general to a plurality of users, the plurality of users including the user and additional users; determining, based on non-access-restricted content obtained responsive to the search over the non-access-restricted database that is general to the plurality of users, whether the request can be satisfied using the non-access-restricted content; and in response to determining that the request can be satisfied using the non-access-restricted content: causing one or more portions of the non-access-restricted content to be rendered at the client device.

In some versions of those implementations, the method may further include, in response to determining that the request cannot be satisfied using the non-access-restricted content: causing a recommendation to initiate an outgoing electronic communication to be rendered at the client device.

In some implementations, determining whether the request is a personal request or a non-personal request and based on processing the request may include: determining whether the request references a personal entity that is associated with the user; and in response to determining that the request reference the personal entity that is associated with the user: determining that the request is a personal request.

In some versions of those implementations, the personal entity that is associated with the user may be one of: a family entity, a friend entity, or a co-worker entity.

In additional or alternative versions of those implementations, causing the access-restricted search to be executed over the access-restricted database that is specific to the user that provided the user input may include: generating, based on the personal entity that is referenced in the request, a personal search query; and executing, over the access-restricted database, the personal search query to obtain the one or more portions of the access-restricted content.

In some further versions of those additional or alternative implementations, determining whether the request can be satisfied using the access-restricted content based on the access-restricted content obtained responsive to the access-restricted search over the access-restricted database that is personal to the user that provided the user input may include: determining whether the one or more portions of the access-restricted content are responsive to the request; and determining, based on the one or more portions of the access-restricted content being responsive to the request, that the request can be satisfied using the access-restricted content.

In some implementations, a method implemented by one or more processors is provided, and includes: receiving user input at a client device of a user, the user input including a request directed to an automated assistant, and the automated assistant being accessible at a client device of the user; determining, based on processing the request, whether the request is a personal request or a non-personal request; and in response to determining that the request is a non-personal request: causing a non-access-restricted search to be executed over a non-access-restricted database that is general to a plurality of users, the plurality of users including the user that provided the user input and additional users that are in addition to the user that provided the user input; determining, based on non-access-restricted content obtained responsive to the non-access-restricted search over the non-access-restricted database that is general to the plurality of users, whether the request can be satisfied using the non-access-restricted content; and in response to determining that the request can be satisfied using the non-access-restricted content: causing one or more portions of the non-access-restricted content to be rendered at the client device.

These and other implementations of technology disclosed herein can optionally include one or more of the following features.

In some implementations, the method may further include, in response to determining that the request cannot be satisfied using the non-access-restricted content: causing a recommendation to initiate an outgoing electronic communication to be rendered at the client device.

In some versions of those implementations, the outgoing electronic communication may be one of: an automated telephone call that is initiated and conducted by the automated assistant and on behalf of the user, or an automated message that is generated and sent by the automated assistant and on behalf of the user.

In some implementations, and in response to determining that the request is a non-personal request, the method may further include: refraining from causing an access-restricted search to be executed over an access-restricted database that is specific to the user that provided the user input.

In some implementations, determining whether the request is a personal request or a non-personal request and based on processing the request may include: determining whether the request references a personal entity that is associated with the user; and in response to determining that the request does not reference the personal entity that is associated with the user: determining that the request is a non-personal request.

In some versions of those implementations, the personal entity that is associated with the user may be one of: a family entity, a friend entity, or a co-worker entity. In additional or alternative versions of those implementations, causing the non-access-restricted search to be executed over the non-access-restricted database that is general to the plurality of users may include: generating, based on a non-personal entity that is referenced in the request, a non-personal search query; and executing, over the non-access-restricted database, the non-personal search query to obtain the one or more portions of the non-access-restricted content.

In some further versions of those additional or alternative implementations, determining whether the request can be satisfied using the non-access-restricted content based on the non-access-restricted content obtained responsive to the non-access-restricted search over the non-access-restricted database that is general to the plurality of users may include: determining whether the one or more portions of the non-access-restricted content are responsive to the request; and determining, based on the one or more portions of the non-access-restricted content being responsive to the request, that the request can be satisfied using the non-access-restricted content.

In some implementations, a method implemented by one or more processors is provided, and includes: determining content of a conversation between a user and an additional user, the content of the conversation being determined based on processing a stream of audio data that captures the conversation between the user and the additional user; determining whether the content of the conversation is personal content or non-personal content; in response to determining that the content of the conversation is personal content: storing one or more portions of the content of the conversation in an access-restricted database that is personal to the user; and in response to determining that the content of the conversation is non-personal content: storing one or more portions of the content of the conversation in a non-access-restricted database that is general to a plurality of users, the plurality of users including the user, the additional user, and further additional users.

These and other implementations of technology disclosed herein can optionally include one or more of the following features.

In some implementations, determining the content of the conversation between the user and the additional user may include: processing, using an automatic speech recognition (ASR) model, the stream of audio data to generate ASR output; and determining, based on processing the ASR output, the content of the conversation.

In some versions of those implementations, determining whether the content of the conversation is personal content or non-personal content may include: processing, using a natural language understanding (NLU) model, the ASR output to generate NLU output; and determining, based on the NLU output, whether the content of the conversation is personal content or non-personal content.

In additional or alternative versions of those implementations, determining whether the content of the conversation is personal content or non-personal content may include: processing, using a large language model (LLM), the ASR output to generate LLM output; and determining, based on the LLM output, whether the content of the conversation is personal content or non-personal content.

In further additional or alternative versions of those implementations, determining whether the content of the conversation is personal content or non-personal content further may include: determining a relationship between the user and the additional user; and determining, based on the relationship between the user and the additional user, whether the content of the conversation is personal content or non-personal content.

In some implementations, determining whether the content of the conversation is personal content or non-personal content further may include: determining a relationship between the user and the additional user; and determining, based on the relationship between the user and the additional user, whether the content of the conversation is personal content or non-personal content.

In some implementations, the conversation between the user and the additional user may be a telephone conversation conducted during a telephone call between the user and the additional user.

In some implementations, the conversation between the user and the additional user may be an in-person conversation conducted while the user and the additional user are co-located in an environment.

In some implementations, the content of the conversation may only include personal content.

In some implementations, the content of the conversation may only include non-personal content.

In some implementations, the content of the conversation may include both personal content and non-personal content.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving user input at a client device of a user, the user input including a request directed to an automated assistant, and the automated assistant being accessible at a client device of the user;
determining, based on processing the request, whether the request is a personal request or a non-personal request; and
in response to determining that the request is a personal request:
causing an access-restricted search to be executed over an access-restricted database that is specific to the user that provided the user input;
determining, based on access-restricted content obtained responsive to the access-restricted search over the access-restricted database that is personal to the user, whether the request can be satisfied using the access-restricted content; and
in response to determining that the request can be satisfied using the access-restricted content:
causing one or more portions of the access-restricted content to be rendered at the client device.

2. The method of claim 1, further comprising:
in response to determining that the request cannot be satisfied using the access-restricted content:
causing a search to be executed over a non-access-restricted database that is general to a plurality of users, the plurality of users including the user and additional users;
determining, based on non-access-restricted content obtained responsive to the search over the non-access-restricted database that is general to the plurality of users, whether the request can be satisfied using the non-access-restricted content; and
in response to determining that the request can be satisfied using the non-access-restricted content:
causing one or more portions of the non-access-restricted content to be rendered at the client device.

3. The method of claim 2, further comprising:
in response to determining that the request cannot be satisfied using the non-access-restricted content:
causing a recommendation to initiate an outgoing electronic communication to be rendered at the client device.

4. The method of claim 3, wherein the outgoing electronic communication is one of: an automated telephone call that is initiated and conducted by the automated assistant and on behalf of the user, or an automated message that is generated and sent by the automated assistant and on behalf of the user.

5. The method of claim 1, further comprising:
in response to determining that the request cannot be satisfied using the access-restricted content:
causing a recommendation to initiate an outgoing electronic communication to be rendered at the client device.

6. The method of claim 5, wherein the outgoing electronic communication is one of: an automated telephone call that is initiated and conducted by the automated assistant and on behalf of the user, or an automated message that is generated and sent by the automated assistant and on behalf of the user.

7. The method of claim 1, further comprising:
in response to determining that the request is a non-personal request:
causing a search to be executed over a non-access-restricted database that is general to a plurality of users, the plurality of users including the user and additional users;
determining, based on non-access-restricted content obtained responsive to the search over the non-access-restricted database that is general to the plurality of users, whether the request can be satisfied using the non-access-restricted content; and
in response to determining that the request can be satisfied using the non-access-restricted content:
causing one or more portions of the non-access-restricted content to be rendered at the client device.

8. The method of claim 7, further comprising:
in response to determining that the request cannot be satisfied using the non-access-restricted content:
causing a recommendation to initiate an outgoing electronic communication to be rendered at the client device.

9. The method of claim 1, wherein determining whether the request is a personal request or a non-personal request and based on processing the request comprises:
determining whether the request references a personal entity that is associated with the user; and
in response to determining that the request reference the personal entity that is associated with the user:
determining that the request is a personal request.

10. The method of claim 9, wherein the personal entity that is associated with the user is one of: a family entity, a friend entity, or a co-worker entity.

11. The method of claim 9, wherein causing the access-restricted search to be executed over the access-restricted database that is specific to the user that provided the user input comprises:
generating, based on the personal entity that is referenced in the request, a personal search query; and
executing, over the access-restricted database, the personal search query to obtain the one or more portions of the access-restricted content.

12. The method of claim 11, wherein determining whether the request can be satisfied using the access-restricted content based on the access-restricted content obtained responsive to the access-restricted search over the access-restricted database that is personal to the user that provided the user input comprises:
determining whether the one or more portions of the access-restricted content are responsive to the request; and
determining, based on the one or more portions of the access-restricted content being responsive to the request, that the request can be satisfied using the access-restricted content.

13. A system comprising:
at least one processor; and
memory storing instructions that, when executed by the at least one processor, cause the at least one processor to be operable to:
receive user input at a client device of a user, the user input including a request directed to an automated assistant, and the automated assistant being accessible at a client device of the user;
determine, based on processing the request, whether the request is a personal request or a non-personal request; and
in response to determining that the request is a personal request:
cause an access-restricted search to be executed over an access-restricted database that is specific to the user that provided the user input;
determine, based on access-restricted content obtained responsive to the access-restricted search over the access-restricted database that is personal to the user, whether the request can be satisfied using the access-restricted content; and
in response to determining that the request can be satisfied using the access-restricted content:
cause one or more portions of the access-restricted content to be rendered at the client device.

14. The system of claim 13, wherein the at least one processor is further operable to:
in response to determining that the request cannot be satisfied using the access-restricted content:
cause a search to be executed over a non-access-restricted database that is general to a plurality of users, the plurality of users including the user and additional users;
determine, based on non-access-restricted content obtained responsive to the search over the non-access-restricted database that is general to the plurality of users, whether the request can be satisfied using the non-access-restricted content; and
in response to determining that the request can be satisfied using the non-access-restricted content:
cause one or more portions of the non-access-restricted content to be rendered at the client device.

15. The system of claim 14, wherein the at least one processor is further operable to:
in response to determining that the request cannot be satisfied using the non-access-restricted content:
causing a recommendation to initiate an outgoing electronic communication to be rendered at the client device.

16. The system of claim 13, wherein the at least one processor is further operable to:
in response to determining that the request cannot be satisfied using the access-restricted content:
cause a recommendation to initiate an outgoing electronic communication to be rendered at the client device.

17. The system of claim 13, wherein the at least one processor is further operable to:
in response to determining that the request is a non-personal request:
cause a search to be executed over a non-access-restricted database that is general to a plurality of users, the plurality of users including the user and additional users;
determine, based on non-access-restricted content obtained responsive to the search over the non-access-restricted database that is general to the plurality of users, whether the request can be satisfied using the non-access-restricted content;
in response to determining that the request can be satisfied using the non-access-restricted content:
cause one or more portions of the non-access-restricted content to be rendered at the client device; and
in response to determining that the request cannot be satisfied using the non-access-restricted content:
cause a recommendation to initiate an outgoing electronic communication to be rendered at the client device.

18. The system of claim 13, wherein the instructions to determine whether the request is a personal request or a non-personal request and based on processing the request comprise instructions to:
determine whether the request references a personal entity that is associated with the user, wherein the personal entity that is associated with the user is one of: a family entity, a friend entity, or a co-worker entity; and
in response to determining that the request reference the personal entity that is associated with the user:
determine that the request is a personal request.

19. The system of claim 18, wherein the instructions to cause the access-restricted search to be executed over the access-restricted database that is specific to the user that provided the user input comprise instructions to:
generate, based on the personal entity that is referenced in the request, a personal search query;
execute, over the access-restricted database, the personal search query to obtain the one or more portions of the access-restricted content; and
wherein the instructions to determine whether the request can be satisfied using the access-restricted content based on the access-restricted content obtained responsive to the access-restricted search over the access-restricted database that is personal to the user that provided the user input comprise instructions to:
determine whether the one or more portions of the access-restricted content are responsive to the request; and
determine, based on the one or more portions of the access-restricted content being responsive to the request, that the request can be satisfied using the access-restricted content.

20. A non-transitory computer-readable storage medium storing instructions that, when executed by at least one processor, cause the at least one processor to be operable to perform operations, the operations comprising:
receiving user input at a client device of a user, the user input including a request directed to an automated assistant, and the automated assistant being accessible at a client device of the user;
determining, based on processing the request, whether the request is a personal request or a non-personal request; and
in response to determining that the request is a personal request:
causing an access-restricted search to be executed over an access-restricted database that is specific to the user that provided the user input;
determining, based on access-restricted content obtained responsive to the access-restricted search over the access-restricted database that is personal to the user, whether the request can be satisfied using the access-restricted content; and
in response to determining that the request can be satisfied using the access-restricted content:
causing one or more portions of the access-restricted content to be rendered at the client device.
